(19) United States
(12) Patent Application Publication
(10) Pub. No.: US 2025/0085119 A1
(43) Pub. Date: Mar. 13, 2025

(54) System And Method For Generating Transportation Recommendations For Improved Efficiency

(71) Applicant: Google LLC, Mountain View, CA (US)

(72) Inventor: Bruce Bahnsen

(21) Appl. No.: 18/571,964

(22) PCT Filed: Jan. 24, 2023
(86) PCT No.: PCT/US2023/011416

§ 371 Date: Dec. 19, 2023

(51) Int. Cl. G01C 21/34; G01C 21/36

(52) U.S. Cl. CPC G01C 21/3423; G01C 21/3469; G01C 21/3617; G01C 21/3697

(57) ABSTRACT

The technology relates to systems and methods for determining one or more alternative modes of transportation for a user. The alternative mode of transportation may improve a value of a transportation metric as compared to a value of the same transportation metric for the user's current mode of transportation. The transportation metrics may be determined based on the user's current mode of transportation and travel history. The transportation metrics may include total travel distances, time spent traveling, the expenses associated with the travel, the carbon footprint from traveling, parking options, specific fueling availability, car maintenance, etc. A value of the transportation metric associated with the alternative mode of transportation may be determined and compared to a value of the transportation metric of the user's current mode of transportation.

### BACKGROUND

As people travel during their daily routines, they may not appreciate the impact of such travel, such as the fuel cost, quantification of harmful emissions into the environment, etc. People often struggle with decisions regarding transportation, such as which type of vehicle to purchase, a best way to get to a particular destination, etc., because it is so difficult to consider all the different factors. As such, while users may have a desire to select environmentally friendly or cost-efficient transportation options, they are often unable to do so effectively.

### BRIEF SUMMARY

The present disclosure generally relates to a system and method for generating tailored recommendations for more efficient transportation based on personal travel patterns and requirements. The tailored recommendations may suggest an alternative mode of transportation as compared to one or more current modes of transportation. The tailored recommendations may improve a value of a transportation metric as compared to a value of the same transportation metric for the user's current mode of transportation. For example, the tailored recommendation may make suggestions to improve a financial, time or environmental cost, such as the user's carbon footprint through more environmentally friendly transportation options.

One aspect of the disclosure relates to a method that may comprise identifying, by one or more processors, at least one first mode of transportation for a user, determining travel information comprising a trip starting point and one or more destination locations, determining, based on the travel information and the at least one first mode of transportation, a value of a transportation metric for the at least one first mode of transportation, determining, based on the travel information, at least one alternative mode of transportation, determining, based on the travel information and at least one alternative mode of transportation, a value of the transportation metric for the at least alternative mode of transportation, comparing the value of the transportation metric associated with the at least one alternative mode of transportation with the value of the transportation metric for the at least one first mode of transportation and providing for output an indication to identify the at least one alternative mode of transportation, wherein the value of the transportation metric associated with the at least one alternative mode of transportation is improved as compared to the value of the transportation metric associated with the at least one first mode of transportation.

In some aspects of the disclosure, the at least one first mode of transportation and the at least one of the at least one alternative mode of transportation may be different from each other. Further, in some examples, the transportation metric may include at least one of a total mileage, a total amount of travel time, a carbon footprint, a driving expense, or vehicle operation data. In some aspects of the disclosure, the vehicle operation data may comprise type of vehicle fuel, vehicle fuel usage, vehicle estimated maintenance, and government incentives related to the vehicle. In some aspects of the disclosure, when determining the transportation metric may be further based on toll information, parking options and fueling options.

Some aspects of the disclosure may further include at least one alternative mode of transportation comprise a plurality of alternative modes of transportation, the method further comprising ranking, based on the value of the transportation metric associated with each of the alternative modes of transportation, plurality of alternative modes of transportation, wherein the ranking of the plurality of alternative modes of transportation is based on a lower cost to user to a highest cost to user. The method may further comprise outputting the ranked plurality of alternative modes of transportation.

Some aspects of the disclosure relate to a method that may further comprising providing for output at least one of the value of the transportation metric for the first mode of transportation and the value of the transportation metric for the at least one alternative mode of transportation. In some aspects of the disclosure, receiving the location information corresponding to the travel history of the user may further include receiving the location information for at least one of a memory device of a user device, one or more servers, or navigational applications. In some aspects of the disclosure, determining the one or more travel information may include determining, based on the location information, a pattern or a frequency of a plurality of trips and identifying, based on the determining pattern or frequency of the plurality of trips, one or more routine trips. In some aspects of the disclosure, when identifying the one or more routine trips based on the frequency of the plurality of trips, the method may further include comparing a frequency of a respective trip of the plurality of trips to a threshold frequency. Further, wherein the frequency of the respective trip is greater than the threshold frequency, the respective trip may be identified as a routine trip.

In some aspects of disclosure, the method may further comprise identifying attributes of the at least one first mode of transportation. The method may further comprise automatically identifying attributes of the at least one first mode of transportation. In some aspects of the disclosure, at least one attribute of the alternative mode of transportation may correspond to at least one attribute of the first mode of transportation. In some aspects of the disclosure, the alternative modes of transportation that do not include the at least one attribute of at least one of the at least one first mode of transportation may be excluded from consideration when identifying the at least one alternative mode of transportation with the improved transportation metric. In some aspects of the disclosure, determining the at least one alternative mode of transportation may further comprise identifying at least one available alternative mode of transportation having the identified attributes. In some examples, determining the at least one alternative mode of transportation may further include receiving, a user selection.

According to some aspects of the disclosure relates to a system that may comprise one or more processors configured to identify at least one first mode of transportation for a user, determine travel information comprising a trip starting point and one or more destination locations, determine, based on the travel information and the at least one first mode of transportation, a value of a transportation metric for the at least one alternative mode of transportation, determine, based on the travel information, at least one alternative mode of transportation, determine, based on the travel information and the at least one alternative mode of transportation, a value of the transportation metric for the at least one alternative mode of transportation, compare the value of the transportation metric associated with the at least one alternative mode of transportation with the value of the transportation metric for the at least one first mode of transportation and provide for output an indication to identify the at least one alternative mode of transportation, wherein the value of the transportation metric associated with the at least one alternative mode of transportation is improved as compared to the value of the transportation metric associated with the at least one first mode of transportation.

In some aspects of the disclosure, the at least one of the at least one first mode of transportation and at least one of the at least one alternative mode of transportation may be different from each other. The transportation metric may include at least one of a total mileage, a total amount of travel time, a carbon footprint, a driving expense, or vehicle operation data. The vehicle operation data may comprise type of vehicle fuel, vehicle fuel usage, vehicle estimated maintenance, and government incentives related to the vehicle. In some aspects of the disclosure, determining the transportation metric may further be based on toll information, parking options and fueling options. In some aspects of the disclosure, the at least one alternative mode of transportation may comprise a plurality of alternative modes of transportation, the method further comprising ranking, based on the value of the transportation metric associated with each of alternative modes of transportation, the plurality of alternative modes of transportation, wherein the ranking of the plurality of alternative modes of transportation is based on a lowest cost to user to a highest cost to user. The system may further comprise the one or more processors configured to output the ranked plurality of alternative modes of transportation. The system may further comprise one or more processors configured to provide for output at least one of the values of the transportation metric for the first mode of transportation and the value of the transportation metric for the at least one alternative mode of transportation.

In some aspects of the disclosure, the system may further comprise one or more processors configured to receive the location information corresponding to the travel history of the user may further include receiving the location information from at least one of memory of a user device, one or more servers, or navigational applications. The system may further comprise one or more processors configured to determine the one or more travel information by determining, based on the location information, a pattern or a frequency of a plurality of trips and identifying, based on the determined pattern or frequency of the plurality of trips, one or more routine trips. The identifying the one or more routine trips based on the frequency of the plurality of trips, the system may be further configured to compare a frequency of a respective trip of the plurality of trips to a threshold frequency. In some examples, when the frequency of the respective trip is greater than the threshold frequency, the respective trip may be identified as a routine trip.

In some aspects of the disclosure, the system may be further configured to automatically identify the attributes of the at least one first mode of transportation. In some examples, at least one attribute of the alternative mode of a transportation may corresponds to at least one attribute of the first mode of transportation. In some examples, any alternative modes of transportation that do not include the at least one attributes of at least one of the at least one first mode of transportation may be excluded from consideration when identifying the at least one alternative mode of transportation with the improved transportation metric. In some examples, determining the at least one alternative mode of transportation further comprises identifying at least one available alternative mode of transportation having the identified attributes. In some examples, determining the at least one alternative mode of transportation may further include receiving a user selection.

### BRIEF DESCRIPTION OF THE DRAWINGS

FIG. 1 is an example screenshot illustrating a user interface for receiving a request to compute transportation metrics for a first mode of transportation in accordance with aspects of the disclosure.

FIG. 2 is another example screenshot illustrating the user interface providing example transportation metrics for the first mode of transportation in accordance with aspects of the disclosure.

FIG. 3 illustrates an example user interface for selection of attributes according to aspects of the disclosure.

FIG. 4 illustrates an example user interface depicting different types of modes of transportation that may be selected by the user for consideration as alternative modes of transportation in accordance with aspects of the disclosure.

FIG. 5 illustrates example predicted transportation metrics for an alternative mode of transportation in accordance with aspects of the disclosure.

FIG. 6A is a functional block diagram of an example system in accordance with aspects of the disclosure.

FIG. 6B is a pictorial diagram of the example system of FIG. 6A in accordance with aspects of the disclosure.

FIG. 7 is a flow diagram illustrating an example method of determining transportation metrics in accordance with aspects of the disclosure.

### DETAILED DESCRIPTION

The technology generally relates to a system and method for generating tailored recommendations for transportation for a user based on automatically determined travel needs for the user. The tailored recommendations may suggest an alternative mode of transportation as compared to one or more current modes of transportation implemented by the user. The tailored recommendations may improve a value of a transportation metric as compared to a value of the same transportation metric for the user's current mode of transportation.

The transportation metrics may assess many travel factors and provide a clear, concise value or values illustrating the effect that changing the user's typical mode of transportation to an optimized transportation plan would have on a certain cost, such as the user's environmental impact, overall travel expenses, etc. The transportation metrics may include, for example, total travel distance, time spent traveling and the expenses associated with the travel such as the financial cost of the journey. Other transportation metrics may include the carbon footprint from traveling, parking options, specific fueling availability, car maintenance, etc.

The value of transportation metrics may be determined for a predetermined period of time. such as a day, week, a month, a year, etc. The value of transportation metrics may be determined based on routine, or regular trips, of the users. In some examples, the value of transportation metrics may be determined based on the mode(s) of transportation of the user for their routine trips.

The value of transportation metrics may be determined automatically without user input. For example, the system may determine routine trips, relevant destinations, etc. based on the travel history of the user and without user input. An objective assessment of routine trips is provided, thereby ensuring an accurate determination of an average value of transportation metrics for the user.

A first value of one or more transportation metrics may be determined based on the user's current mode of transportation and travel history. For example, the user's travel history may be used to determine how far they drive, how much time they spend driving, etc. in a given period of time. Based on that information and their current mode of transportation, the value of the one or more transportation metrics, such as fuel consumption, carbon footprint, wear and-tear, etc. may be determined. Values of other transportation metrics that may be determined may include, for example, total ownership or rental costs for a given time period, insurance rates, maintenance, etc.

A second value of the one or more transportation metrics may be determined based on a suggested alternative mode of transportation and the user's travel history. Similar to determining the first value of the one or more transportation metrics, the second value of the one or more transportation metrics may be determined based on the user's travel history, such as the distance traveled, time spent driving, etc., in a given period of time. Based on that information, e.g., the user's travel history, and their current mode of transportation, the value of the one or more transportation metrics for the suggested alternative mode of transportation, such as fuel consumption, carbon footprint, wear and-tear, etc. may be determined. Values of other transportation metrics that may be determined may include, for example, total ownership or rental costs for a given time period, insurance rates, maintenance, etc.

The second value of the one or more transportation metrics may be determined based on different transportation options, such that the second value is improved as compared to the first value. For example, where the first and second values quantify carbon footprint, the second value may represent a reduced carbon footprint as compared to the first value.

By automatically determining the current values of one or more transportation metrics for a user and predicted values of the one or more transportation metrics, a user is provided with an objective and accurate indication of at least one alternative mode of transport which improves the value of the one or more transportation metric. Further, the user can make a well-informed decision to reduce their travel costs and improve their lifestyle by choosing at least one alternative mode of transportation that improves the value of the one or more transportation metrics. In some examples, the determined value of the one or more transportation metrics may be used to identify more cost efficient or environmentally conscious routes that match user preferences to keep the value of the one or more transportation metrics under a threshold amount. Additionally or alternatively, the determined values of the one or more transportation metrics may be used to determine alternative modes of transportation that meet or are below a threshold value of the one or more transportation metrics. This may increase energy efficiency and decrease travel expenses for the user.

The value of the one or more transportation metrics may be used to evaluate the impact that changing the user's typical route has on a given transportation metrics. For example, the predicted value of the one or more transportation metrics may provide an indication of the total miles to be traveled, anticipated car maintenance associated with routine use, total amount of travel time, travel expenses, such as estimated cost of fuel, availability of fueling options, tickets for public transportation, the carbon footprint caused by the traveling, etc. that a user would experience when traveling their routine trips or to relevant destinations using an optimized route.

According to some examples, the value of one or more transportation metrics may be used to identify alternative modes of transportation. For example, if the user's current mode of transportation is a pickup truck, an alternative mode may be a sedan, electric bike, public transportation, carpools, etc.

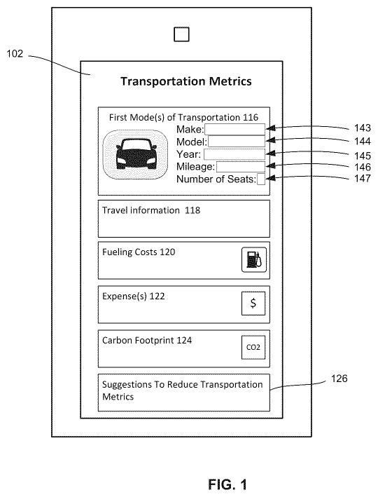

FIG. 1 illustrates an example display of an application 102 showing options for transportation metrics. As shown in this example, the transportation metrics include travel information 118, fueling costs 120, travel expense(s) 122, and carbon footprint 124. The value of the transportation metrics may be determined based on a user's current mode(s) of transportation, travel information 118, such as a user travel history and/or location information, etc.

When determining the value of the transportation metrics, the system may identify a first mode of transportation 116 for the user. The first mode of transportation 116 may be, for example, the user's existing mode of transportation. The mode of transportation may be, for example, a type of vehicle, public transportation, ride shares, taxis, etc.

According to some examples, the first mode of transportation 116 may include one or more modes of transportation. For example, the first mode of transportation may include a plurality of vehicles, a combination of vehicle types, such as internal combustion engine (“ICE”) vehicles, hybrid vehicles, or electric vehicles (“EV”), bikes, public transportation, etc.

The user's current mode of transportation may be determined based on information received as input from the user. For example, the system may receive inputs corresponding to the make 143, model 144, year 145, mileage 146, number of seats 147, maintenance history, etc. of the mode of transportation. The inputs may be provided as a drop-down menu, sliding scale, radio button, etc. for selecting the information regarding the first mode of transportation 116. According to some examples, instead of having the various inputs listed, a pop-up, overlay, etc. may be provided in response to receiving an input corresponding to a selection of the first mode of transportation 116. Within pop-up may be inputs that allow the user to provide information regarding the current mode of transportation 116 from the user.

Additionally or alternatively, the first mode of transportation 116 may be determined based on the user's location information and/or travel history, such as by detecting public transportation routes, tolls routes, etc. The system may scan the user's travel history and detect that the user frequently travels a path that matches local bus routes and/or that the user's times of travel match a bus schedule along the same route. The system may take that information to determine that the user's first mode of transportation is public transportation, specifically city buses. Similarly, the system may scan the user's travel information and detect if the user frequently pays for tolls specific to high occupancy vehicle (HOV) lanes. The system may use this information to deduce that the user's first mode of transportation includes a carpool. This information may be used later to help determine alternative modes of transportation. For example, the system will use this information to determine if the user is eligible for carpool or HOV benefits, such as reduced tolls or use of designated lanes.

Additionally or alternatively, the first mode of transportation 116 may be determined based on the user's location information and/or travel history based on the information from their ride sharing applications The system may use information from a ride sharing application profile to determine the user's travel information. For example, the user's profile may indicate the frequency at which the user requests rides through the application, and such information may be used to infer that the user's first mode of transportation is ride sharing options.

The user's travel history or travel information 118 may be based on location information provided by a personal device, a navigational system, a mapping application, etc. Location information may be, for example, data collected by a device having a location sensor, such as a global positioning system (GPS), that illustrates the locations a user has traveled to. In some examples, location information may include destinations identified in e-mails, calendar appointments, etc. to which the user has allowed the system access.

The location information may be stored locally on the personal device or navigational system. In some examples, the location information may be shared to a remote location, such as a remote server. According to some examples, the location information may be used to identify types of destinations visited and the frequency such that the system does not require or obtain the specific destination location. For example, the system may recognize the user visits a specific chain of gas stations, but not one particular location of the chain. The system may use this location information to better understand and predict the user's route and suggest alternative modes of transportation.

The personal device may be any device that includes a location sensor, such as a smart phone, tablet, laptop, smart watch, AR/VR headset, smart helmet, etc. The navigational system may be, in some examples, integrated into a user's vehicle or personal device. The devices and navigational systems may be devices that have hardware capable of identifying a user's location. The hardware may be, for example, the location sensor. The mapping application may be, for example, an application that is executed by the personal device or vehicle.

The user may consent to sharing their location information and travel information. For example, the user may provide authorization to an application for determining transportation metrics. The authorization may be for the application to access one or more databases or sub-databases in the memory of the device, vehicle, remote server, etc. According to one example, the user may select specific sub-databases to which the application is granted access. For instance, the user may grant access to the location history database but not the calendar archive database.

Based on the user's travel information 118, the system may determine a type of trip based on a respective starting location and destination location. The type of trip may be a routine trip or a non-routine trip. A routine trip may be a trip that occurs with a regular or routine frequency such that routine trip creates a pattern in the travel information. This pattern may be a repeated or regular occurrence over a specified period of time. The pattern may be identified by the time of day the trip occurs, the time of year the trip is taken, if the trip occurs bi-weekly, one a month, etc. In some examples, a routine trip may be a trip that occurs at or above a threshold frequency. The threshold frequency may be, in some examples, daily, three times a week, three times a month, etc. A non-routine trip may be a trip that does not occur with a pattern. In some examples, a non-routine trip may be a trip that occurs below a threshold frequency.

The user's travel information may be used to identify a user's routine trips to destinations. Examples of routine trips may include a user's commute to work, dropping off and picking up the user's dry cleaning, weekly food-shopping trips, etc. Routine trips may include a starting location and a destination location. In some examples, routine trips may include a starting location and two or more destination locations. Destinations may be, for example, locations frequented by the user. In some examples, the user's travel history may be used to identify destinations or types of destinations, such as a pet groomer, nail salon, barber shop, pool supply store, etc.

According to some examples, the system may determine the aggregate value of the one or more transportation metrics for a plurality of users that share the current mode of transportation. For example, the plurality of users may live within the same residential unit. The primary user may select members of a household to include in the transportation metrics value calculations. The system may, with the consent of each user, determine the value of one or more transportation metrics for each user based on each user's mode of transportation and travel information. The system may further combine the values of the one or more transportation metrics for each selected user to determine a value of a household transportation metric. For example, in a household of three selected users, the system may determine and consider the individual values of the one or more transportation metrics to suggest combined routes, thus reducing the value of the household transportation metric.

According to some examples, the system may identify, based on the user's travel information, location pairs. Location pairs may include starting location and destination locations of a trip. The system may identify the starting location based on user input, information from position sensors such as GPS, etc. The destination locations may be identified based on locations entered into navigation applications, calendar events, e-mails, position sensors, etc. In some instances, a trip may include stops between the starting location and destination location. For example, the user may make a stop at a coffee shop while traveling between a starting and destination location.

The system may determine a pattern or frequency for each identified starting and destination location pair. The pattern for each identified starting and destination location pair may be, for example, whether the trip occurs on the same day of the week, at the same time each day, on the same day each month, once a month, etc. In some examples, the pattern may be whether the trip occurs during a certain part of the year, such as seasonal trips or school year pick-ups and drop-offs. In yet another example, the pattern may be whether the trip occurs during a certain part of the day, such as a user's daily commute at the same time each day.

The frequency for each identified starting and destination location pair may be a measure of how often the starting or destination location is traveled to by the user within a given time period. For example, the frequency of a trip may be once a day, multiple times a day, every Tuesday and Thursday, every 4 days, multiple times a month, etc. If the system determines, based on the user's travel information, that the trip for a given starting and destination location pair is completed more than a threshold number of times in a given time period, the system may determine that pair to be a routine trip to be included when determining the value of the one or more transportation metrics. Additionally or alternatively, if the system determines that the trip for a given location pair does not occur more than a threshold number of times in a given time period, the system may determine that pair to be a non-routine trip.

According to some examples, the system may use a machine learning (“ML”) model to determine whether a trip is a routine trip or a non-routine trip. The ML model may be trained to determine whether a trip is a routine trip. Each training example may consist of a starting location and a destination location. The input features to the ML model may be the frequency of the trip. The ML model may use the input features to more accurately determine whether the trip is a routine trip. The output of the ML model may be a determination of whether the trip is a routine trip. In some examples, the system may ask for feedback from the user. For example, the user may be asked to confirm whether the trip is a routine trip. The user may provide feedback, such as a yes or no, indicating that the determination was correct.

The user's travel information may be used to identify destinations or destination types frequented by the user. In some examples, the destinations may be destinations frequented by the user, saved in the user's address book, identified by the user as relevant, etc.

Destinations frequented by the user may be used when determining the value of one or more transportation metrics regardless of whether the destination is outside a given threshold. For example, the system may identify destinations of a trip as a destination to be included if the system determines a user has visited the destination more than a predetermined number of times in a given time period. In some examples, the system may receive inputs from the user identifying a destination as relevant. In such an example, the system may receive inputs for a respective destination location identifying the location as relevant, not relevant, visited periodically, etc. In some examples, the system may receive inputs identifying the destination location as a type of location, such as “work”, “gym”, “doctor's office”, etc. The system may identify labeled destinations as destinations to be included when determining the value of one or more transportation metrics.

As such, by automatically determining travel information based on the data received by the system (such as average distance traveled or computed distance), the system beneficially determines improved options for alternative modes of transportation that objectively provide an average reduction in fuel consumption, travel time, fuel emission, transit time, travel cost and/or distance traveled for users. While a single transportation metric has been discussed in the above examples, the determination of an alternative mode of transportation may be based on multiple transportation metrics.

As mentioned above, since a user searching through information provided by various entities and manually aggregating the data is cumbersome, computationally intensive, and time consuming, by automating determination of travel information corresponding to data specific to the user, an improved value of one or more transportation metrics, this may increase the efficiency of the system.

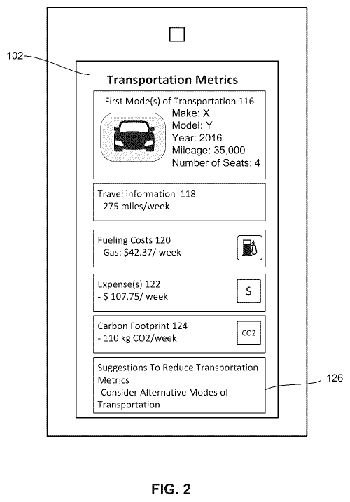

FIG. 2 illustrates example values of the transportation metrics based on mode of transportation and travel information. For example, the transportation metrics may be based on the user's current mode of transportation and trips identified as being routine trips or destinations identified as relevant destinations. Additionally or alternatively, the system may determine values of the transportation metrics based on expected traffic and road conditions based on the predictive time of when driving has to occur. The values of the transportation metrics may be determined based on the identified trips and/or relevant destinations in relation to type of mode of transportation. For example, the system may determine the travel information 118 and use the travel information to determine the value of the transportation metrics, such as fueling costs 120, expenses 122, carbon footprint 124, etc. The expenses 122 may be, for example, expenses associated with the mode of transportation, such as anticipated car maintenance and monthly payments. According to some examples, the system may determine, based on the travel information 118 and the first mode of transportation 116 suggestions to reduce the value of transportation metrics, such as alternative routes, different times of days to make a trip to reduce the amount of traffic the user will encounter, different parking options, etc.

According to some examples, the system may have access to an online database of vehicle features. The online database may include information regarding specific to particular make, models and years of various modes of transportation. Specifically, the database may have information regarding features of particular models of vehicles based on the vehicles year, such as fuel efficiency, emissions, highway mileage per gallon, fuel capacity, seat capacity, storage capacity, cost of ownership fees, etc. The system may use the database when determining the value of one or more transportation metrics based on the determined or inputted vehicle attributes.

According to some examples, the system may use a ML model to determine vehicle features associated with various modes of transportation when determining the value of one or more transportation metrics. The ML model may be trained using a plurality of training examples including different modes of transportation. Feature input for the ML model may include features such as fuel efficiency, emissions, highway mileage per gallon, fuel capacity, scat capacity, storage capacity, cost of ownership fees, etc. The ML model may use the input features to determine the value of one or more transportation metrics of the current mode of transportation. The output of the ML model may be a determination of whether the feature should be included when determining the value of one or more transportation metrics. In some examples, the system may ask for feedback from the user. For example, the user may be asked to confirm whether the determined features were accurate. The user may provide feedback, such as a yes or no, indicating that the determination was correct.

The system may use the user's travel information 118 for a period of time corresponding to the predetermined period of time used to determine the value of one or more transportation metrics. For example, if the value of the transportation metrics is for two weeks in September, the system may use the user's travel information 118 from two weeks in the most recent September when calculating the value of the transportation metrics for the current mode of transportation.

In some examples, the system may determine the value of the transportation metrics based on the user's travel information, current mode of transportation, and/or transportation metrics based on one or more additional modes of transportation. The system may make suggestions to reduce the value of one or more transportation metrics 126. These suggestions 126 may include recommended changes that would reduce the value of one or more transportation metrics determined for the first mode of transportation. For example, if the user has a first mode of transportation, such as a large SUV, and a second mode of transportation available to them, such as an electric vehicle, the system may determine that the value of a transportation metric may be improved if the user utilizes the second mode of transportation instead of the first mode of transportation when completing routine trips having fewer than 5 passengers or trips requiring only limited trunk space for luggage/equipment. In another example, as depicted in FIG. 2, the suggestions 126 may include considering an alternate mode of transportation. The system may determine that the value of a transportation metric may be improved by utilizing an alternative mode of transportation, such as public transit or carpools, for completing at least some of the routing or non-routine trips.

According to some examples, a value of the transportation metric may include fueling costs 120 associated with the first mode of transportation 116. The fueling costs 120 may include, for example, local gas prices, local charging prices, accessibility of charging or gas stations along the user's regular route, etc. The fueling costs 120 associated with the first mode of transportation 116 may be determined based on the user's travel information 118. For example, based on the total mileage driven in a given time period and the first mode of transportation, the system may determine the fueling costs 120 for that given time period based on the average cost of fuel in the area. As shown in FIG. 2, knowing that the first mode of transportation is a 2016 make “X” model “Y” sedan, the system may determine the average miles per gallon for the mode of transportation. As an example, the average miles per gallon for the first mode of transportation 116 may be 22 miles per gallon. The system may determine, based on the user's travel history, that the user typically travels 275 miles per week. To determine the fueling costs to travel 275 miles/week, the system may determine how many gallons of gas would be required for the mode of transportation 116. For example, the system may divide the miles per week, 275, by the miles per gallon for the mode of transportation, 22. In this example, the user would need 12.5 gallons of gas for the week. The fueling cost for the week would be the gallons of gas needed, 12.5, multiplied by the cost of the gas. While the example shown in FIG. 2 is based on a time period of a week, the duration, or period of time, may be for a day, week, month, year, etc. Accordingly, the example shown in FIG. 2 is just one example and is not intended to be limiting.

According to some examples, a value of the transportation metric may include expenses 122 associated with the first mode of transportation 116. The expenses 122 may include, for example, car payments, insurance rates, standard maintenance costs, etc. Standard maintenance costs may include, for example, regular oil changes, tire replacements, break maintenance, etc. The expenses 122 associated with the first mode of transportation 116 may be determined based on the user's travel information 118. For example, based on the routine routes, destinations, total mileage driven in a given time period and the first mode of transportation 116, the system may determine the expenses 122 for that given time period. As shown in FIG. 2, knowing that the first mode of transportation is a 2016 make “X” model “Y” sedan, the system may determine, or identify, the regular maintenance suggested for the specific mode of transportation. As an example, the determined first mode of transportation 116 may require oil changes every 8,250 miles. The system may determine, based on the user's travel information 118, that the user typically travels 275 miles per week. To determine the expense of getting the vehicle's oil changed, the system may determine how many weeks the user would have to travel to reach the point where the oil change would be needed, every 30 weeks. The system would divide the anticipated cost of the oil change by the number of weeks before one is needed and apply that number to the transportation metric for expenses 122. In another example, the system may factor in travel expenses such as tolls along the routine route taken by the user or parking costs based on the user's destinations. As shown in FIG. 2, knowing that the first mode of transportation is a 2016 make “X” model “Y” sedan, the system may determine the amount of tolls charged based on the toll roads frequented by the user. As an example, the toll road on the user's route to work five days of the week may charge $2.50 for two axel vehicles and $5 for vehicles with more than two axels. The system may determine that a first mode of transportation is a sedan and calculate the $2.50 five times a week in the expenses 122 transportation metric. While the example shown in FIG. 2 is based on a time period of a week, the duration, or period of time, may be for a day, week, month, year, etc. Accordingly, the example shown in FIG. 2 is just one example and is not intended to be limiting.

According to some examples, a value of the transportation metric may include a carbon footprint 124 associated with the first mode of transportation 116 and the user's travel information 118. The carbon footprint 124 may be determined based on the distance the user travels and the first mode of transportation 116. As shown in FIG. 2, knowing that the first mode of transportation is a 2016 make “X” model “Y” sedan, the system may determine the emissions factor of the first mode of transportation 116, wherein the emissions factor is the amount of CO2 emitted by the combustion of one gallon of that fuel. The equation to determine the carbon footprint of a mode of transportation based on the user's travel history is as follows :

$$CF = g \times EF$$

Where CF is the determined carbon footprint, g is the amount of gas needed per week, and EF is the emissions factor. For example, the emissions factor of the first mode of transportation 116 may be 0.4. The system may determine, based on the user's travel history, that the user typically travels 275 miles per week. To determine the carbon footprint of travelling 275 miles/week, the system may determine how many gallons of gas would be required for the mode of transportation 116. For example, the system may divide the miles per week, 275, by the miles per gallon for the mode of transportation, 22. In this example, the user would need 12.5 gallons of gas for the week. The carbon footprint 124 for the week would be the gallons of gas needed, 12.5, multiplied by the emissions factor. While the example shown in FIG. 2 is based on a time period of a week, the duration, or period of time, may be for a day, week, month, year, etc. Accordingly, the example shown in FIG. 2 is just one example and is not intended to be limiting.

According to some examples, the system may identify attributes of the first mode of transportation 116 and use the identified attributes when determining the value of the transportation metrics. The attributes may include, for example, the type of transportation, the model, make, seat capacity, year, fuel efficiency, an estimate of initial cost of vehicle, etc.

According to some examples, the system may receive an input corresponding to the current mode of transportation having a plurality of users. The system may determine the aggregate value of one or more transportation metrics for the current mode of transportation based on the travel information of the plurality of users that utilize the current mode of transportation. Each user of the vehicle may consent to sharing their location information and travel information for the purposes of determining the value of the one or more transportation metrics.

In some examples, the system may determine that a first user of the plurality of users is the primary user of the first mode of transportation and the remainder of users are secondary users. For example, the first mode of transportation may be a vehicle that is shared by multiple users in a household. In this example, the system may indicate a primary user, such as first user, and a secondary user, such as second user. The indication of primary and secondary users may be determined based on the travel history of the users. For example, the primary user may be the user that spends the utilizes the vehicle more for regular trips as compared to the secondary user.

In some examples, the system may determine there are a plurality of user of the current mode of transportation based on shared qualities of amongst the users, such as a shared home address, similar travel history and/or routine trips, time spent together at specific locations, etc.

When considering multiple users and multiple current modes of transportation, the system may automatically determine which user utilizes which mode of transportation at the highest frequency to assign specific modes of transportation to each user. For example, the system may recognize that the primary user most frequently uses a pickup truck, whereas the second user most frequently uses a hybrid vehicle. This information may be taken into account when determining the value of their transportation metrics. The system may use the primary user's current mode of transportation, the pickup truck, and the primary user's travel history to compute the value of the primary user's transportation metric. Similarly, the system may use the secondary user's current mode of transportation, the hybrid vehicle, and the secondary user's travel history to compute the value of the secondary user's transportation metric. The value of the primary and secondary users' metrics will be correlated or combined to obtain the value of a household transportation metric.

In all examples, location sharing is authorized by the users, and the users may withdraw authorization at any time, such as by adjusting settings on the user's electronic device.

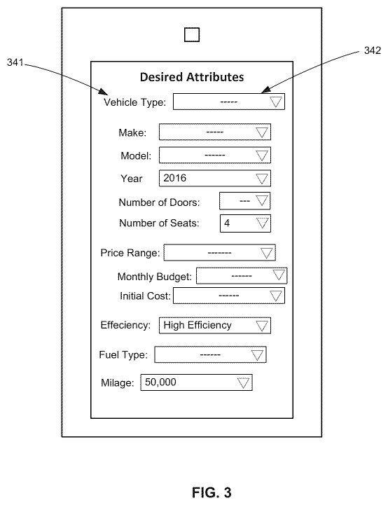

FIG. 3 illustrates example inputs corresponding to criteria for an alternative mode of transportation. The alternative mode of transportation may be a mode of transportation that is not currently being utilized by the user, not currently owned or leased by the user, etc. For example, if the current mode of transportation for the user is a sedan that is owned by the user, an alternative mode of transportation may be a sedan having a different make, model, and/or year, a coupe, minivan, pickup truck, public transportation, such as a bus, rideshare or carpool, etc. The alternative mode of transportation may be used suggested as a partial replacement to the current mode, such as using the alternative mode on only a portion of the user's routine trips, or it may be suggested as a complete replacement. In other examples, a combination of alternative transportation modes may be suggested.

The system may receive information corresponding to the criteria requested for an alternative mode of transportation. The criteria may include, for example, the vehicle type, make, model, year, number of doors, number of seats, price range, maximum price, minimum price, initial costs, monthly costs, expenses associated with the mode of transportation, fuel efficiency, fuel type, mileage range, etc. While the inputs are shown as drop down menus, the input may be radio buttons, sliding scales, a range indicator, pictorial diagrams, etc. Accordingly, the inputs shown and the selection option shown are only some examples and are not intended to be limiting.

According to some examples, the system may receive inputs for one or more criteria. For example, the system may receive an input corresponding to the number of seats required by the user. According to some examples, the system may use the travel history as described above to autofill inputs for one or more of the criteria. For example, the system may determine, based on the user's travel history, the vehicle is a high efficiency vehicle. As depicted in FIG. 3, the display may show the attributes 341 on one side of the screen and user input modules 342 on the opposite side of the screen. The attributes 341 may be, for example, the type of transportation, the model, make, seat capacity, year, fuel efficiency, initial cost of vehicle, etc. The user input module 342 corresponding to the attribute 341 may have predetermined selections based on the attribute. For example, the user input module 342 for the number of door attribute may show selections for 2, 3 or 4 doors. The user input module 342 may have predetermined selections based on user's inputs for other attributes 341. For example, if the user selects a hybrid vehicle for the vehicle type attribute, the system will limit the make attribute input options within the user input module 341 associate with that attribute to cars with hybrid options.

In some examples, the system can automatically determine attributes of an alternative mode of transportation. For example, the system may receive input for a vehicle of interest and populate the attributes of the vehicle to determine the value of one or more of its transportation metrics. According to some examples, the system may identify features of the first mode of transportation and use the identified attributes to determine alternative modes of transportation. Additionally or alternatively, the system may automatically determine criteria for an alternative mode of transportation based on the travel information 118. For example, the system may identify, based on the user's routine routes, that the value of one or more of the user's transportation metrics could be reduced by using an electric vehicle. The system would automatically input the vehicle type as electric. As another example, the system may identify, based on the value of a household transportation metric, that a household could reduce the value of their transportation metric by reducing the number of vehicles of the household and purchasing a vehicle with larger seating capacity. The system would automatically input the higher seat capacity for the alternative mode of transportation into the system.

According to some examples, the system may identify one or more alternative modes of transportation based on the user's budgeted transportation costs. For example, the system may receive input corresponding to the user's weekly, monthly, yearly, etc. budget. The system may compare the received budget to a budget threshold to identify an alternative mode of transportation that matches or improves a value of a transportation metric of the current mode of transportation. The budget threshold may equal the user's weekly, monthly, yearly, etc. budget.

According to some examples, an alternative mode of transportation may be identified for routine trips, non-routine trips, all travel, etc. For example, an alternative mode of transportation may be identified as improving the value of one or more transportation metrics for routine trips, non-routine trips, all travel, etc. In one example, the value of one or more transportation metrics of the user's current mode of transportation for one or more non-routine trips may be compared to the value of one or more transportation metrics for an alternative mode of transportation for the same non-routine trips. Continuing with this example, if the user's current mode of transportation is an electric car, the system may determine the value of one or more transportation metrics of the electric car non-routine trips identified based on the user's travel information. A non-routine trip may be, for example, a cross country trip for vacation. Based on the value of the one or more transportation metrics for the electric vehicle, the system may identify one or more alternative modes of transportation that improve the value of at least one of the one or more transportation metrics. For example, the system may identify air travel or train as an alternative mode of transportation. In such an example, while the travel expense for air travel or train travel may be greater as compared to using the electric car, utilizing air or train travel may decrease the travel time and travel distance. The system may determine that using another form of travel, e.g., air or train, would improve the value of the transportation metric (the transportation metric being travel time or travel distance in this example) as compared to using the current mode of transportation, e.g., the electric car. As such, the transportation metric to be improved may be predetermined via user selection or preference such that suggested alternative modes of transportation improve the predetermined transportation metric. In this way, the user is able to customize the transportation metric to be improved, such as a reducing travel time or a reducing travel distance. The methods described herein may therefore include a step of selecting a transportation metric to be improved, receiving an input selecting a transportation metric to be improved.

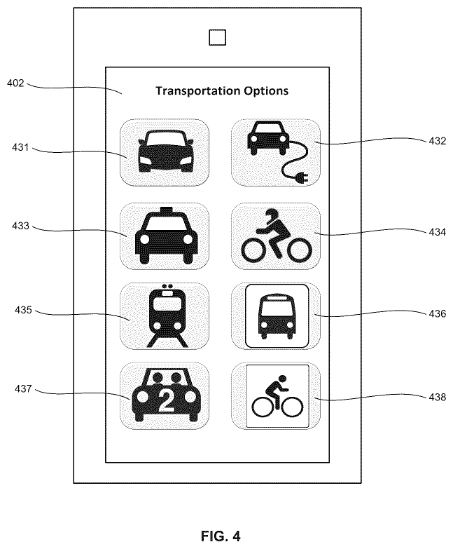

FIG. 4 illustrates a display in which the user may select a category of modes of transportation. The categories of modes of transportation may include an internal combustion vehicle (“ICE”) vehicle 431, a hybrid vehicle/an electric vehicle 432, ride share options/taxis 433, two wheeled options 434 such as electric or motor bikes, public transportation, including but not limited to subways/trains 435, and buses 436, carpooling options 437, and manual bicycles 438. The user may choose one or multiple categories for the system to choose from when suggesting alternative modes of transportation. For example, the user may select the ICE vehicle, electric vehicle and train categories as acceptable modes of transportation for the system to suggest. In response, the system may suggest a route that would lower the value of one or more transportation metrics that include an electric vehicle and trains.

The system may utilize values of transportation metrics for different modes of travel to determine one or more alternative modes of transportation. The alternative mode of transportation may be the mode of travel which provides an improvement in the value of one or more transportation metrics. For example, the alternative mode of transportation may decrease the fuel consumption, carbon footprint, overall cost of owning the mode of transportation, may decrease daily travel expenses, may increase the miles per gallon, etc.

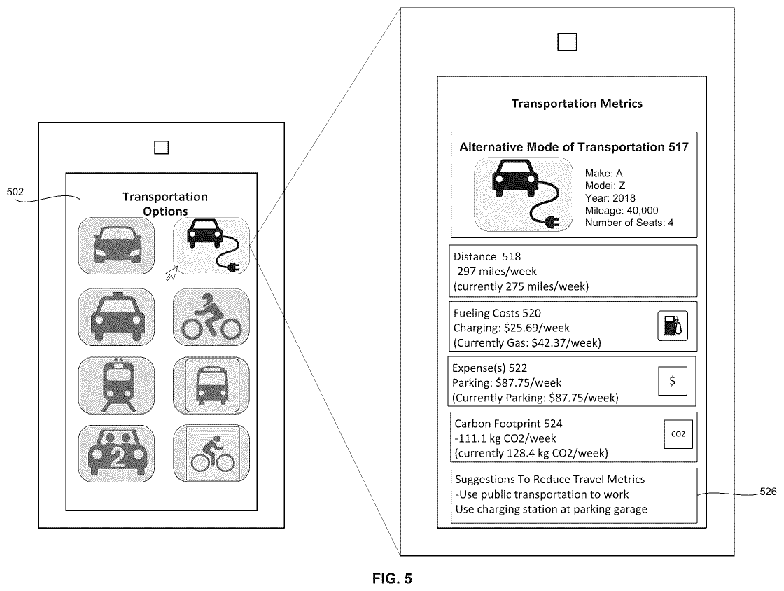

FIG. 5 illustrates example output of the predicted value of one or more transportation metrics. While travel information 518, fueling costs 520, expenses 522, and carbon footprint 524 are all shown, the system may output only the predicted value of one or some of the transportation metrics. For example, the application 502 may include a menu option that allows the user to select which transportation metrics to be shown.

According to some examples, the system may determine a value of a transportation metric based on the user's travel information and current mode of transportation. The output of the system may include an identification of an alternative mode of transportation 517. For example, the system may identify alternative modes of transportation based on the user's travel information, transportation attributes, etc. The transportation attributes may include, for example, type of transportation, such as motorcycle, car, truck, SUV, carpool, public transportation, etc., initial ownership cost, fuel efficiency, maintenance costs, etc. The system may determine a value of the transportation metric for the identified alternative modes of transportation. In some examples, the system may select an alternative mode of transportation 517 based on a car listing recently reviewed by the user. In some examples, the application 502 may include an input for the user to provide the mode of transportation. For example, the user may input desired attributes of a mode of transportation or a make and model the user is interested in.

According to some examples, the system may use a ML model to determine vehicle features associated with various modes of transportation when determining the value of one or more transportation metrics. The ML model may be trained using a plurality of training examples including different modes of transportation. Feature input for the ML model may include features such as a fuel efficiency, emissions, highway mileage per gallon, fuel capacity, seat capacity, storage capacity, cost of ownership fees, etc. The ML model may use the input features to more accurately determine how the value of the transportation metrics of the alternative mode of transportation compare to the current mode of transportation. The output of the ML model may be a determination of whether the alternative mode of transportation should be included when suggesting ways to reduce the value of one or more transportation metrics. In some examples, the system may ask for feedback from the user. For example, the user may be asked to confirm whether an alternative mode of transportation was a suitable fit for their needs. The user may provide feedback, such as a yes or no, indicating that the determination was correct.

The system may compare the value of the one or more transportation metrics for the current mode of transportation with each of the alternative modes of transportation. The comparison may be used to identify which mode of transportation provides an improved value of the one or more transportation metrics. In some examples, the system may select the alternative mode of transportation 517 based on a mode of transportation that would likely decrease the value of one or more of the user's transportation metrics as compared to their current mode of transportation. In this manner, the user is able to obtain an objective measure of how the alternative mode of transportation 517 would affect the value of one or more of their transportation metrics on the assumption that all the routine trips are maintained. As such, the described method automatically either provides options of suggested alternative modes of transportation that would reduce the value of one or more of the user's transportation metrics, were the user to utilize any of the suggested alternative modes of transportation, or is able to automatically select the alternative mode of transportation 517 for the user as a mode that would decrease the value of one or more of the user's transportation metrics. For example, the automatically chosen alternative mode of transportation 517 may reduce the user's fueling costs 520, expenses 522, or carbon footprint 524. Such transportation metrics may be based on the assumption that the user will maintain all the routine trips.

According to some examples, the system may compute the value of one or more transportation metrics for numerous modes of transportation simultaneously. As such, the user may review multiple suggestions for alternative modes of transportation, such as by clicking on the different categories. According to some examples, some modes of transportation may be excluded from consideration or computation of transportation metric values. For example, modes of transportation that cannot accommodate the user's needs, such as occupancy requirements, trunk space, fuel type, etc., may be excluded from consideration. In this regard, an optimal mode of transportation may be determined in a computationally efficient manner.

As shown in FIG. 5, the predicted value of the one or more transportation metrics 518-524 may be output as text indicating the amount of time, distance, expense, carbon footprint, etc. per period of time, e.g., per week. However, the predicted value of the one or more transportation metrics 518-524 may be output based on any predetermined period of time, such as a day, week, month, three months, year, etc. In some examples, the predicted value of the one or more transportation metrics 518-524 may be output in graphical format, such as a histogram, pie chart, etc.

According to some examples, the predicted value of the one or more transportation metrics 518-524 may include an indication of the predicted value of the one or more transportation metrics and the current value of the one or more transportation metrics. The current value of the one or more transportation metrics may be the value of the one or more transportation metrics based on the user's current mode of transportation, such as the user's current vehicle. The user may use the predicted value of the one or more transportation metrics when evaluating the effect on the user's overall travel based on changing the user's current mode of transportation to the alternative mode of transportation. This may be helpful, for example, when evaluating a vehicle purchase.

The distance 518, based on data collected from the routine trips user's travelling over a predetermined period of time, may be 297 miles a week. In contrast, the user's current distance for their routine trips, based on their travel information, may be 275 miles a week. Accordingly, the user may determine, based on the distance metric, that they may drive an additional 22 miles a week to accommodate the alternative mode of transportation. In this example, the system will take into account that the alternative mode of transportation is an electric vehicle that will need to be charged at public charging stations to function, which may be scarce along the user's routine route requiring additional driving.

The fueling costs 520 to travel to the relevant destinations or suggested alternative destinations, based on the alternative mode of transportation 517, may be $25.69 per week. In contrast, the user's current fueling costs 520 for their routine trips and to their relevant destinations, based on current mode of transportation, may be $43.37 per week. Accordingly, the transportation metrics may indicate that the user may save $17.68 each week if they changed their mode of transportation.

The expenses 522 to travel to the relevant destinations or suggested alternative destinations, based on the alternative mode of transportation 517, may be $87.75 per week. Similarly, the user's current expenses 522 for their routine trips and to their relevant destinations, based on their current mode of transportation, may be $87.75 per week. Accordingly, the transportation metrics may indicate that the user's expenses may not change from the alternative mode of transportation from the current mode of transportation. In this example, the system may recognize that the expenses would be the same or similar to the current mode of transportation. For example. If the current mode of transportation and the suggested alternative mode of transportation are around both 4 door sedans, the expense for parking the vehicle in the same parking lot may remain the same.

The carbon footprint 524 to travel to the relevant destinations or suggested alternative destinations, based on the alternative mode of transportation 517, may be 111.1 kg CO2 per week. In contrast, the user's current carbon footprint 524 for their routine trips and to their relevant destinations, based on their current mode of transportation, may be 128.4 kg CO2 per week. Accordingly, the user may determine, based on the carbon footprint 524 metric that they may save 17.3 kg CO2 each week if they changed their mode of transportation.

Based on the mode of transportation providing the improved value, the system may provide one or more suggestions to improve the value of one or more of their transportation metrics. According to some examples, the system may output suggestions to reduce the value of one or more transportation metrics 526 based on the predicted value of the one or more transportation metrics 518-524. The suggestions to reduce the value of the one or more transportation metrics may include using public transportation for certain routine trips or using more convenient fueling options, etc. The suggestions also may include, for example, switching from a first mode of transportation to a second mode of transportation. For example, the system may provide suggestions to switch from ICE vehicle to using public transportation. In some examples, the suggestions may include purchasing another vehicle that would reduce the value of one or more transportation metrics of the user. For example, the system may suggest selling current vehicle and purchasing a vehicle that uses alternative fuel, such as electric or a hybrid model, or is more cost effective to park at regular destination points. In some examples, the suggestions may include switching the time a user travels to the destination location. For example, if the user typically takes the highway to arrive at work, the system may suggest taking an alternative route to avoid traffic thereby lessening the user's travel time. The suggestions may, additionally or alternatively, include public transportation options for one or more trips. For example, the system may suggest taking a bus to work or riding a bike to the bank instead of driving in order to reduce the value of one or more transportation metrics (the one or more transportation metrics being travel time, in this example).

According to some examples, the system may provide suggestions to improve the value of one or more transportation metrics based on the aggregate value of the one or more transportation metrics for the plurality of users utilizing the mode of transportation. For example, the system may provide suggestions to combine user's regular routes to reduce the number of vehicles needed in a household. In some examples, the suggestions may include public transportation options for one household member. For example, the system may provide suggestions for one household member to travel to with a second household member to a public transportation stop along the second member's route to reduce the number of vehicles required, thus reducing the household value of the one or more transportation metrics.

According to some examples, the output may include suggestions of an alternate mode of transportation, such as an alternative vehicle, in order to provide an improvement in the value of the transportation metric when travelling to the destination locations. For example, the output may include an indication showing one or more alternative modes of transportation, including other vehicle options and public transportation options, that have the same predicted value of the transportation metric as compared to a current value of the user's transportation metric or a predicted value of the transportation metric that is improved compared to the current value of the user's transportation metric. Improving the value of the transportation metric may comprise reducing the value of the transportation metric. Providing an indication for output may comprise providing an indication for display on, or output via, a device of the user, such as highlighting, selecting or otherwise indicating the alternative mode of transportation as providing an improvement in the transportation metric.

According to some examples, the system may determine an alternative mode of transportation based on the travel information of the plurality of users that utilize the current mode of transportation. Each user of the vehicle may content to sharing their location information and travel information for purposes of determining the value of one or more transportation metrics.

In some examples, the system may determine that a first user of the plurality of users is the primary user of the first mode of transportation and the remainder of users are secondary users. For example, the first mode of transportation may be a vehicle that is shared by multiple users in a household. In this example, the system may indicate a primary user, such as first user, and a secondary user, such as second user. The indication of primary and secondary users may be determined based on the travel history of the users. For example, the primary user may be the user that spends the utilizes the vehicle more for regular trips as compared to the secondary user.

In some examples, the system may determine there are a plurality of users of the current mode of transportation based on shared qualities of amongst the users, such as a shared home address, similar travel history and/or routine trips, time spent together at specific locations, etc.

When considering multiple users and multiple current modes of transportation, the system may automatically determine which user utilizes which mode of transportation at the highest frequency to assign specific modes of transportation to each user. For example, the system may recognize that the primary user most frequently uses a pickup truck, whereas the second user most frequently uses a hybrid vehicle. This information may be taken into account when determining the value of their transportation metrics. In some examples, the system may make suggestions about which of the plurality of users should use which mode of transportation. For example, the system may suggest the primary user utilizes the first of the alternative modes of transportation suggests and the secondary user utilizes the second of the alternative modes of transportation.

In all examples, each selected user must individually consent and authorize sharing their location information with the system to be accounted for when determining the value of one or more transportation metrics for current mode of transportation and suggestions of alternatives.

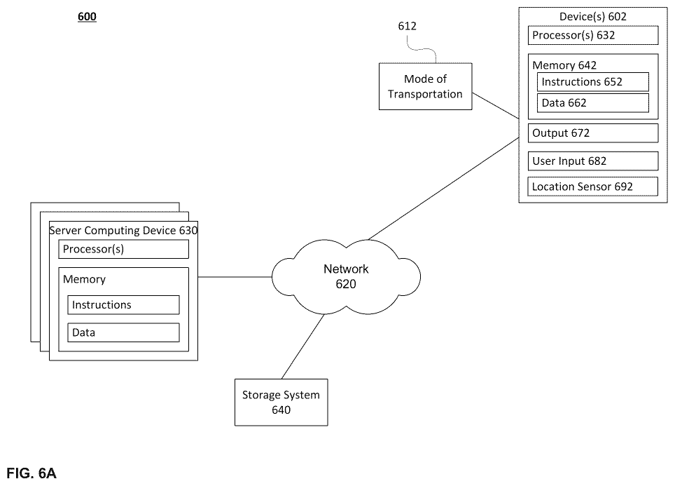

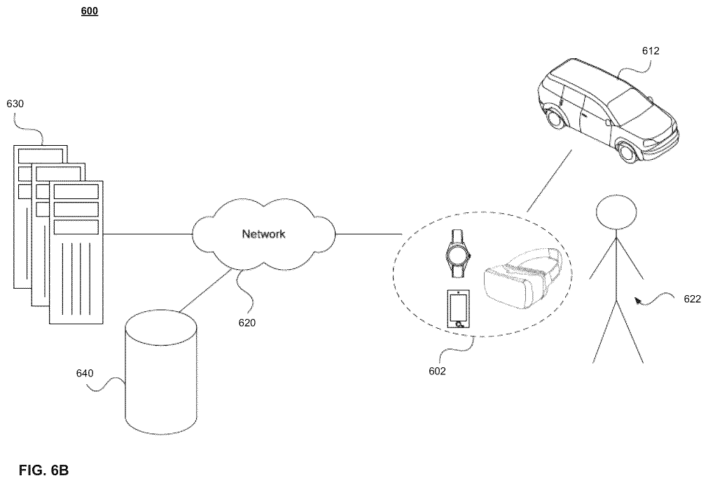

FIG. 6A illustrates an example system 600 in which the features described above may be implemented. It should not be considered limiting the scope of the disclosure or usefulness of the features described herein. In this example, system 600 may include device(s) 602, mode(s) of transportation 612, server computing device 630, storage system 640, and network 620.

Each of devices 602 may include one or more processors 632, memory 642, data 662 and instructions 652. Each of devices 202 may also include an output 672, user input 682, and location sensor 692. The devices 202 may be any device that includes a location sensor 692, such as a smart phone, tablet, laptop, smart watch, AR/VR headset, smart helmet, etc., as shown in FIG. 6B.

Memory 642 of devices 602 may store information that is accessible by processor 632. Memory 642 may also include data that can be retrieved, manipulated or stored by the processor 632. The memory 642 may be of any non-transitory type capable of storing information accessible by the processor 632, including a non-transitory computer-readable medium, or other medium that stores data that may be read with the aid of an electronic device, such as a hard-drive, memory card, read-only memory (“ROM”), random access memory (“RAM”), optical disks, as well as other write-capable and read-only memories. Memory 642 may store information that is accessible by the processors 632, including instructions 652 that may be executed by processors 632, and data 662.

Data 662 may be retrieved, stored or modified by processors 632 in accordance with instructions 652. For instance, although the present disclosure is not limited by a particular data structure, the data 662 may be stored in computer registers, in a relational database as a table having a plurality of different fields and records, XML documents, or flat files. The data 662 may also be formatted in a computer-readable format such as, but not limited to, binary values, ASCII or Unicode. By further way of example only, the data 662 may comprise information sufficient to identify the relevant information, such as numbers, descriptive text, proprietary codes, pointers, references to data stored in other memories (including other network locations) or information that is used by a function to calculate the relevant data,

The instructions 652 can be any set of instructions to be executed directly, such as machine code, or indirectly, such as scripts, by the processor 632. In that regard, the terms “instructions,” “application,” “steps,” and “programs” can be used interchangeably herein. The instructions can be stored in object code format for direct processing by the processor, or in any other computing device language including scripts or collections of independent source code modules that are interpreted on demand or compiled in advance. Functions, methods and routines of the instructions are explained in more detail below.

The one or more processors 632 may include any conventional processors, such as a commercially available CPU or microprocessor. Alternatively, the processor can be a dedicated component such as an ASIC or other hardware-based processor. Although not necessary, computing devices 602 may include specialized hardware components to perform specific computing functions faster or more efficiently.

Although FIG. 6A functionally illustrates the processor, memory, and other elements of devices 602 as being within the same respective blocks, it will be understood by those of ordinary skill in the art that the processor or memory may actually include multiple processors or memories that may or may not be stored within the same physical housing. Similarly, the memory may be a hard drive or other storage media located in a housing different from that of the devices 602. Accordingly, references to a processor or device will be understood to include references to a collection of processors or devices or memories that may or may not operate in parallel.

Output 672 may be a display, such as a monitor having a screen, a touch-screen, a projector, or a television. The display 672 of the one or more computing devices 602 may electronically display information to a user via a graphical user interface (“GUI”) or other types of user interfaces. For example, as will be discussed below, display 672 may electronically display a map interface identifying relevant destinations, routine trips, or one or more transportation metrics and values thereof based on a specified starting location.

The user input 682 may be a mouse, keyboard, touch-screen, microphone, or any other type of input. The user input may receive the user's authorization to use the location sensor 692 to obtain location information for the transportation metrics. For example, the user can select particular applications for which to allow location services, particular times during which location services can be enabled, or other permissions or limitations for the location services.

The location sensor 692 may be, for example, a global positioning system (“GPS”) sensor, wireless communications interface, etc. The location sensor 692, when enabled by the user, may provide a rough indication as to the location of the device. According to some examples, when authorized by the user, the location sensors may provide location information indicating relevant destinations or routine trips.

The location information may be stored locally on the device 602 or navigational system. such as part of an application or integrated into vehicle 612. In some examples, the location information may be shared to a remote location, such as a remote server 630 or storage system 640. According to some examples, the location information may be used to identify types of destinations visited and the frequency such that the system does not require or obtain the specific destination location.

The devices 602 can be at various nodes of a network 620 and capable of directly and indirectly communicating with other nodes of network 620. Although three (3) computing devices are depicted in FIG. 6A, it should be appreciated that a typical system can include one or more computing devices, with each computing device being at a different node of network 620. The network 620 and intervening nodes described herein can be interconnected using various protocols and systems, such that the network can be part of the Internet. World Wide Web, specific intranets, wide area networks, or local networks. The network 620 can utilize standard communications protocols, such as WiFi, Bluetooth, 4G, 5G, etc., that are proprietary to one or more companies. Although certain advantages are obtained when information is transmitted or received as noted above, other aspects of the subject matter described herein are not limited to any particular manner of transmission.

In one example, system 600 may include one or more server computing devices 630 having a plurality of computing devices, e.g., a load balanced server farm, that exchange information with different nodes of a network for the purpose of receiving, processing and transmitting the data to and from other computing devices. For instance, one or more server computing devices 630 may be a web server that is capable of communicating with the one or more client computing devices 602 via the network 620. In addition, server computing device 630 may use network 620 to transmit and present information to a user of one of the other computing devices 602 or a passenger of a vehicle. In this regard, vehicles 612 may be considered client computing devices. Server computing device 630 may include one or more processors, memory, instructions, data, location sensors, etc. These components operate in the same or similar fashion as those described above with respect to computing devices 602.

As shown in FIG. 6B, each device 602 may be a personal computing device intended for use by a respective user 622, and have all of the components normally used in connection with a personal computing device including one or more processors (e.g., a central processing unit (CPU)), memory (e.g., RAM and internal hard drives) storing data and instructions, an output, such as a display (e.g., a monitor having a screen, a touch-screen, a projector, a television, or other device such as a smart watch display that is operable to display information), and user input devices (e.g., a mouse, keyboard, touchscreen or microphone). The devices may also include a camera for recording video streams, speakers, a network interface device, and all of the components used for connecting these elements to one another. Devices 602 may be capable of wirelessly exchanging or obtaining data over the network 620.

Although the client computing devices may each comprise a full-sized personal computing device, they may alternatively comprise mobile computing devices capable of wirelessly exchanging data with a server over a network such as the Internet. By way of example only, devices 602 may be mobile phones or devices such as a wireless-enabled PDA, smartphones, a tablet PC, a wearable computing device (e.g., a smartwatch, AR/VR headset, smart helmet, etc.), or a netbook that is capable of obtaining information via the Internet or other networks.

User 622 may operate a respective vehicle 612. The vehicle 612 may include a location sensor. In some examples, vehicle 612 may include an integrated navigation system. According to some examples, the navigation system may be integrated into a user's 622 respective device 602. In yet another example, the device 602 or vehicle 612 may execute a mapping application that provides maps or directions, identifies a user's location, etc.

Any use of location information or travel history of a user 622 is authorized by the respective user. For example, the user 622 may provide authorization to an application for determining the value of one or more transportation metrics by setting certain permissions for the application. The authorization may be for the application to access one or more databases or sub-databases in the memory of the device, vehicle, remote server, etc. According to one example, the user may select specific sub-databases to which the application is granted access. For instance, the user may grant access to the location history database but not the calendar archive database.

Mode of transportation 612 may include a computing device (not shown). The computing device may include one or more components similar to devices 602, such as one or more processors, memory, data, instructions, a display, a user input, etc. According to some examples, modes of transportation 612 may include a perception system for detecting and performing analysis on objects external to the mode of transportation such as other vehicles, obstacles in the roadway, traffic signals, signs, trees, etc. Additionally or alternatively, the perception system may determine whether the vehicle is in motion or parked. For example, the perception system may include lasers, sonar, radar, one or more cameras, or any other detection devices which record data which may be processed by a computing device (not shown) within the modes of transportation 612. In the case where the vehicle is a small passenger vehicle such as a car, the car may include a laser mounted on the roof or other convenient locations as well as other sensors such as cameras, radars, sonars, and additional lasers (not shown).

Storage system 640 may store various types of information. For instance, the storage system 640 may store data or information related to a user's location information, such as the user's travel information, places of interest for the user, relevant destinations, etc. In some examples, storage system 640 may store data or information related to destinations, or points of interest (“POI”), for retrieval in response to a request to determine the value of one or more transportation metrics. As used herein, POIs may include any location, or destination, that a user can visit, such as an office building, apartment complex, home address, barber shop, nail salon, big-box store, local hardware store, park, green space, restaurant, theater venue, amusement park, shopping center, etc.

Storage system 640 may store map data. This map data may include, for instance, locations of POIs, locations of driving lanes, parking lanes, designated parking areas, no parking zones, drop off locations, etc. Map data may also include locations, road names, road configurations, etc.

According to some examples, storage system 240 may store data or information related to a user's 622 location information after receiving authorization from the user 622. The authorization may be, for example, provided by setting permissions for the system to access location information and travel history. For example, a user may be provided with controls allowing the user to make an election as to both if and when systems, programs, or features described herein may enable collection of location information, and if the user is sent content or communications from a server. In addition, certain data may be treated in one or more ways before it is stored or used, so that personally identifiable information is removed. The user may have control over what information is collected about the user, how that information is used, and what information is provided to the user. The user's 622 location information or travel history may be used to identify, or determine, a user's 622 routine trips or relevant destinations.

While FIGS. 6A and 6B illustrate a single user 622 and their respective device(s) 602 and vehicle 612, it should be understood that there may be multiple users and their respective devices and vehicles. The location information and travel information of each user may be used to determine a respective user's travel information. Each user's location information and travel history may be aggregated and used to illustrate the average or medial value of one or more transportation metrics for a given area, such as a neighborhood, town, city, county, state, etc.

Each respective user provides authorization for an application to access their location information and travel information. The user may set permissions for the application to indicate what location information and travel history the application may access. The location information may be stored locally on the user device. In some examples, the location information from the user device(s) and/or navigational applications may be shared with and, therefore, stored by one or more servers. In yet another example, the location information may be captured and stored by navigational applications. The location information and travel history may only be shared with and stored by servers after a user authorizes the sharing of location information and travel information.

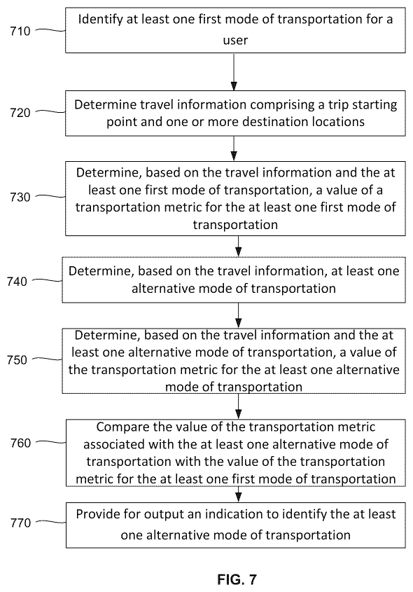

FIG. 7 illustrates an example method for determining the predicted value of one or more transportation metrics for a user based on the user's travel information and mode of transportation. The following operations do not have to be performed in the precise order described below. Rather, various operations can be handled in a different order or simultaneously and operations may be omitted.

In block 710, the system may identify at least one first mode of transportation for a user. A first mode of transportation for the user may be the user's existing mode of transportation, such as a type of vehicle utilized by the user. According to some examples, the first mode of transportation may include one or more modes of transportation. For example, the existing mode of transportation may include a plurality of vehicles, a combination of vehicles, bikes, public transportation, etc. In some examples, the system may receive an indication of the current mode of transportation from the user. Additionally or alternatively, the system may determine the first mode of transportation based on the user's travel history, such as by detecting public transportation routes, tolls routes, ride sharing, etc.

In block 720, the system may determine travel information comprising a trip starting point and one or more destination locations. The user's travel history or travel information may be based on location information provided by a personal device, a navigational system, a mapping application, etc. Location information may be, for example, data collected by a device having a location sensor, such as a global positioning system (GPS), that illustrates the locations a user has traveled to. In some examples, location information may include destinations identified e-mails, calendar appointments, etc. that the user has allowed the system access to. The locations identified by the location information may correspond to destinations, such as the destination location of a trip or a relevant destination.

In block 730, the system may determine, based on the travel information and the at least one first mode of transportation, a value of a transportation metric for the at least one first mode of transportation. When determining the value of the transportation metric for the first mode of transportation, the system may take into account expenses associated with the first mode of transportation, such as car payments, insurance rates, fueling costs, standard maintenance costs, etc. Standard maintenance costs may include, for example, regular oil changes, tire replacements, break maintenance, etc. According to some examples, the system may identify attributes of the first mode of transportation and use the identified attributes when determining the value of the transportation metric. The attributes may include, for example, the type of transportation, the model, make, seat capacity, year, fuel efficiency, an estimate of initial cost of vehicle, etc.

In block 740, the system may determine, based on the travel information, at least one alternative mode of transportation. The system may receive an indication of the requisite attributes for the alternative mode of transportation. For example, the system may receive an input corresponding to the number of seats required by the user. In some examples, the system may receive input for attributes corresponding to the type of transportation, the model, make, seat capacity, year, fuel efficiency, initial cost of vehicle, etc. In some examples, the system can automatically determine attributes of an alternative mode of transportation. For example, the system may receive input for a vehicle of interest and populate the attributes of the vehicle to determine the value of one or more of its transportation metrics. According to some examples, the system may identify features of the first mode of transportation and use the identified attributes to determine alternative modes of transportation.

In block 750, the system may determine, based on the travel information and the at least one alternative mode of transportation, a value of the transportation metric for the at least one alternative mode of transportation. When determining the value of one or more transportation metrics for the alternative mode of transportation, the system may take into account expenses associated with the alternative mode of transportation, such as car payments, insurance rates, fueling costs, standard maintenance costs, etc. Standard maintenance costs may include, for example, regular oil changes, tire replacements, break maintenance, etc. According to some examples, the system may identify attributes of the alternative mode of transportation and use the identified attributes when determining the value of one or more transportation metrics. The attributes may include, for example, the type of transportation, the model, make, seat capacity, year, fuel efficiency, an estimate of initial cost of vehicle, etc.

In block 760, the system may compare the value of the transportation metric associated with the at least one alternative mode of transportation with the value of the transportation metric for the at least one first mode of transportation. The comparison may be used to identify which mode of transportation provides an improved value of the transportation metric. In some examples, the system may select the alternative mode of transportation based on a mode of transportation that would likely decrease the value of the transportation metric as compared to their current mode of transportation. In this manner, the user is able to obtain an objective measure of how the alternative mode of transportation would affect the value of the transportation metric on the assumption that all the routine trips are maintained.

In block 770, the system may provide for output an indication to identify the at least one alternative mode of transportation. According to some examples, the system may output suggestions to reduce the value of the transportation metric to the predicted value of the transportation metric. The output may include suggestions of an alternate vehicle in order provide an improvement in the value of the transportation metric when traveling to the destination locations, such as switching from a first mode of transportation to the alternative mode of transportation. For example, the system may suggest selling current vehicle and purchasing a vehicle that uses alternative fuel, such as electric or a hybrid model, or is more cost effective to park at regular destination points.

Unless otherwise stated, the foregoing alternative examples are not mutually exclusive. but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method, comprising:
identifying, by one or more processors, at least one first mode of transportation for a user;
determining, by the one or more processors, travel information comprising a trip starting point and one or more destination locations;
determining, by the one or more processors based on the travel information and the at least one first mode of transportation, a value of a transportation metric for the at least one first mode of transportation;
determining, by the one or more processors based on the travel information, at least one alternative mode of transportation;
determining, by the one or more processors based on the travel information and the at least one alternative mode of transportation, a value of the transportation metric for the at least one alternative mode of transportation;
comparing, by the one or more processors, the value of the transportation metric associated with the at least one alternative mode of transportation with the value of the transportation metric for the at least one first mode of transportation; and
providing for output, by the one or more processors, an indication to identify the at least one alternative mode of transportation,
wherein the value of the transportation metric associated with the at least one alternative mode of transportation is improved as compared to the value of the transportation metric associated with the at least one first mode of transportation.

2. The method of claim 1, wherein at least one of the at least one first mode of transportation and at least one of the at least one alternative mode of transportation are different from each other.

3. The method of claim 1, wherein the transportation metric includes at least one of a total mileage, a total amount of travel time, a carbon footprint, a driving expense, or vehicle operation data.

4. The method of claim 3, wherein the vehicle operation data comprises type of vehicle fuel, vehicle fuel usage, vehicle estimated maintenance, and government incentives related to the vehicle.

5. The method of claim 1, wherein determining the transportation metric is further based on toll information, parking options and fueling options.

6. The method of claim 1, wherein the at least one alternative mode of transportation comprises a plurality of alternative modes of transportation, the method further comprising ranking, by the one or more processors based on the value of the transportation metric associated with each of the alternative modes of transportation, the plurality of alternative modes of transportation, wherein the ranking of the plurality of alternative modes of transportation is based on a lowest cost to user to a highest cost to user.

7. The method of claim 6, further comprising outputting, by the one or more processors, the ranked plurality of alternative modes of transportation.

8. The method of claim 1, further comprising providing for output, by the one or more processors, at least one of the value of the transportation metric for the first mode of transportation and the value of the transportation metric for the at least one alternative mode of transportation.

9. The method of claim 1, further comprising receiving the location information corresponding to the travel history of the user further includes receiving, by the one or more processors, the location information from at least one of a memory of a user device, one or more servers, or navigational applications.

10. The method of claim 1, wherein determining the one or more travel information includes:
determining, by the one or more processors based on the location information, a pattern or a frequency of a plurality of trips; and
identifying, based on the determined pattern or frequency of the plurality of trips, one or more routine trips.

11. The method of claim 10, wherein when identifying the one or more routine trips based on the frequency of the plurality of trips, the method further includes comparing a frequency of a respective trip of the plurality of trips to a threshold frequency.

12. The method of claim 11, wherein when the frequency of the respective trip is greater than the threshold frequency, the respective trip is identified as a routine trip.

13. The method of claim 1, further comprising identifying, by the one or more processors, attributes of the at least one first mode of transportation.

14. The method of claim 13, further comprising automatically identifying the attributes of the at least one first mode of transportation.

15. The method of claim 13, wherein at least one attribute of the alternative mode of transportation corresponds to at least one attribute of the first mode of transportation.

16. The method of claim 15, wherein alternative modes of transportation that do not include the at least one attribute of at least one of the at least one first mode of transportation are excluded from consideration when identifying the at least one alternative mode of transportation with the improved transportation metric.

17. The method of any of claims 13, wherein determining the at least one alternative mode of transportation further comprises identifying, by the one or more processors, at least one available alternative mode of transportation having the identified attributes.

18. The method of claim 1, wherein determining the at least one alternative mode of transportation further includes receiving, by the one or more processors, a user selection.

19. A system, comprising:
one or more processors, the one or more processors configured to:
identify at least one first mode of transportation for a user;
determine travel information comprising a trip starting point and one or more destination locations;
determine, based o the travel information and the at least one first mode of transportation, a value of a transportation metric for the at least one first mode of transportation;
determine, based on the travel information, at least one alternative mode of transportation;
determine, based on the travel information and the at least one alternative mode of transportation, a value of the transportation metric for the at least one alternative mode of transportation;
compare the value of the transportation metric associated with the at least one alternative mode of transportation with the value of the transportation metric for the at least one first mode of transportation; and
provide for output an indication to identify the at least one alternative mode of transportation,
wherein the value of the transportation metric associated with the at least one alternative mode of transportation is improved as compared to the value of the transportation metric associated with the at least one first mode of transportation.

20. The system of claim 19, wherein at least one of the at least one first mode of transportation and at least one of the at least one alternative mode of transportation are different from each other.

21.-36. (canceled)
